(19) United States
(12) Patent Application Publication
(10) Pub. No.: US 2012/0150710 A1
(43) Pub. Date: Jun. 14, 2012

(54) METHOD AND SYSTEM FOR FACILITATING ACCESS TO FINANCIAL INFORMATION

(75) Inventors: Johannes Marthinus Eloff, Pretoria (ZA); Willem Johannes Baard, Pretoria (ZA)

(73) Assignee: HOPAC (PROPRIETARY) LIMITED, Menlo Park (ZA)

(21) Appl. No.: 13/391,610

(22) PCT Filed: Aug. 20, 2010
(86) PCT No.: PCT/IB2010/053766

§ 371 Date: Feb. 21, 2012

(30) Foreign Application Priority Data
Aug. 21, 2009 (ZA) 2009/05829

(51) Int. Cl. G06Q 40/02

(52) U.S. Cl. 705/35

(57) ABSTRACT

The present invention relates to a method 110 and system 10 for facilitating access to financial information of a bank account holder by a requester 27. The method 110 includes receiving a request message 30 (40) via a card reader terminal 12, the request message 30 including details of a bank account associated with a bank card read by a card reader 20 of the card reader terminal 12; and sending a response message 32 (50) including a code for decrypting or accessing financial information associated with the bank account, the financial information thus being made securely available to the requester 27. The financial information may be in the form of at least one bank statement. The response message 32 may include at least two codes, namely a transaction code and a decryption key, for accessing the financial information.

### FIELD OF INVENTION

This invention relates to a method and system for facilitating access to financial information.

### BACKGROUND

The Inventor is aware of the current practice of business entities (e.g. merchants) to require, at times, a bank account holder to submit certain financial information, such as bank statements for the past three months, in order to initiate business transactions. This can by time-consuming and frustrating for a bank account holder, since it requires him to go to his bank to obtain the bank statements, before the business transaction can be initiated. It is also sometimes required for the bank statements to be validated by the bank, e.g. by means of an official stamp.

The Inventor wishes to provide bank account holders with a more convenient, and also more secure, way of providing business entities with such information.

### SUMMARY OF INVENTION

According to a first aspect of the invention, there is provided a method of facilitating access to financial information of a bank account holder by a requester, the method including:
receiving a request message via a card reader terminal, the request message including details of a bank account associated with a bank card read by a card reader of the card reader terminal; and
sending a response message including a code for decrypting or accessing financial information associated with the bank account, the financial information thus being made securely available to the requester.

The term “requester” is understood to mean any entity or party requesting or interested in receiving financial information, including merchants or vendors, credit providers, auditors, and the like.

The financial information may be in the form of a bank statement (also known as a statement of account) and may include a plurality (e.g. three months) of bank statements.

The response message may include a plurality of codes, for example a transaction code as well as a decryption key, for accessing the financial information.

The method may further include generating and sending an information message including the financial information. Generating the information message may include encrypting the financial information. The information message may be sent to an intermediary for temporary interim storage, or may be sent directly to the requester. In the case of the former, the financial information may be stored, at least temporarily, on an intermediary database.

The response message may include an indication of where/how the financial information (e.g. the bank statements) may be accessed. The indication may be in the form of a link (e.g. a URL) pointing to a website.

According to a second aspect of the invention, there is provided a method of facilitating access to financial information of a bank account holder, the method including:
reading from a bank card by a card reader of a card reader terminal details of a bank account associated with the bank card;
sending a request message from the card reader terminal, the request message including the details of the bank account; and
receiving a response message including a code for decrypting or accessing financial information associated with the bank account, the financial information thus being made securely available.

The method may include receiving a confirmation (e.g. a pin code or a signature) from the bank account holder confirming that the financial information may be made available.

The response message may include an indication of where/how the financial information may be accessed. The indication may be in the form of a link (e.g. a URL) pointing to a website.

The method may include:
receiving a user input indicative of the code;
sending a query message (e.g. via the website) including the code; and
receiving an information message, in response to the code being validated, including the financial information.

The information message may be received from a secure database by using the code. More specifically, the financial information may be accessed through a network, such as the Internet, by logging on to a secure server.

The financial information may be in the form of a bank statement (also known as a statement of account) and may include a plurality (e.g. three months) of bank statements.

According to a third aspect of the invention, there is provided a method of facilitating access to financial information to a requester, the method including:
inserting a bank card into a card reader of a card reader terminal, thereby allowing details of a bank account associated with the bank card to be read;
initiating sending of a request message, the request message including details of a bank account associated with the bank card; and
receiving a response message including a code for decrypting or accessing financial information associated with the bank account, the financial information thus being made securely available to the requester.

The method may include providing a requester with a confirmation (e.g. a pin code or a signature) confirming that the financial information may be accessed. More specifically, the confirmation may include an authorisation statement which is to be signed, to confirm or authorise to the requester access to the financial information. Thus, the method may also include signing the statement and handing it to the requester.

According to a fourth aspect of the invention, there is provided a method of facilitating access to financial information of a bank account holder by a requester, the method including:
receiving an information message including the financial information of the bank account holder from the bank account holder's bank, the financial information being encrypted by an encryption key; and
providing access to the financial information in response to receiving a valid transaction code.

The step of providing selective access may include:
receiving a query message (e.g. via a website) including an indication of the transaction code;
validating the transaction code to determine whether or not it is valid; and
forwarding the information message, in response to a determination that the transaction code is valid, including the financial information.

The method may include decrypting the financial information before forwarding the information message.

The method may include deleting the financial information either after the information has been accessed once, or after the information has not been accessed within a predetermined time.

According to a fifth aspect of the invention there is provided a system for facilitating access to financial information of a bank account holder by a requester, the system including:
a server which is configured to receive and process a request message received via a card reader terminal, the request message including details of a bank account associated with a bank card read by a card reader of the card reader terminal, and to send a response message including a code for decrypting or accessing financial information associated with the bank account, the financial information thus being made securely available to the requester.

The system may include at least one card reader terminal. More specifically, the system may include a plurality of card reader terminals.

The financial information may be in the form of a bank statement (also known as a statement of account) and may include a plurality (e.g. three months) of bank statements.

The response message may include a plurality of codes, for example a transaction code as well as a decryption key, for accessing the financial information.

The response message may also include an indication of where/how the financial information (e.g. the bank statements) may be accessed. The indication may be in the form of a link (e.g. a URL) pointing to a website.

The system may include an intermediary which is configured to receive an information message, including financial information, generated and sent from a bank server. The bank server may encrypt the financial information prior to sending it to the intermediary. The intermediary may store the information message, including the financial information, at least temporarily, on an intermediary database.

The intermediary may be configured to provide access to the financial information, in response to receiving a valid code.

The intermediary may be configured to delete the financial information either after the information has been accessed once, or after the information has not been accessed within a predetermined time.

The invention extends further to a computer-readable medium including a set of instructions which, when executed by a computer, causes the computer to perform a method as defined above.

### BRIEF DESCRIPTION OF THE DRAWINGS

The invention will now be described by way of example, with reference to the accompanying diagrammatic drawings.

In the drawings:

FIG. 1 shows a schematic view of a system for facilitating access to financial information of a bank account holder by a requester, in accordance with the invention; and

FIG. 2 shows a flow diagram of a method of facilitating access to financial information, in accordance with the invention.

### DETAILED DESCRIPTION OF PREFERRED EMBODIMENT

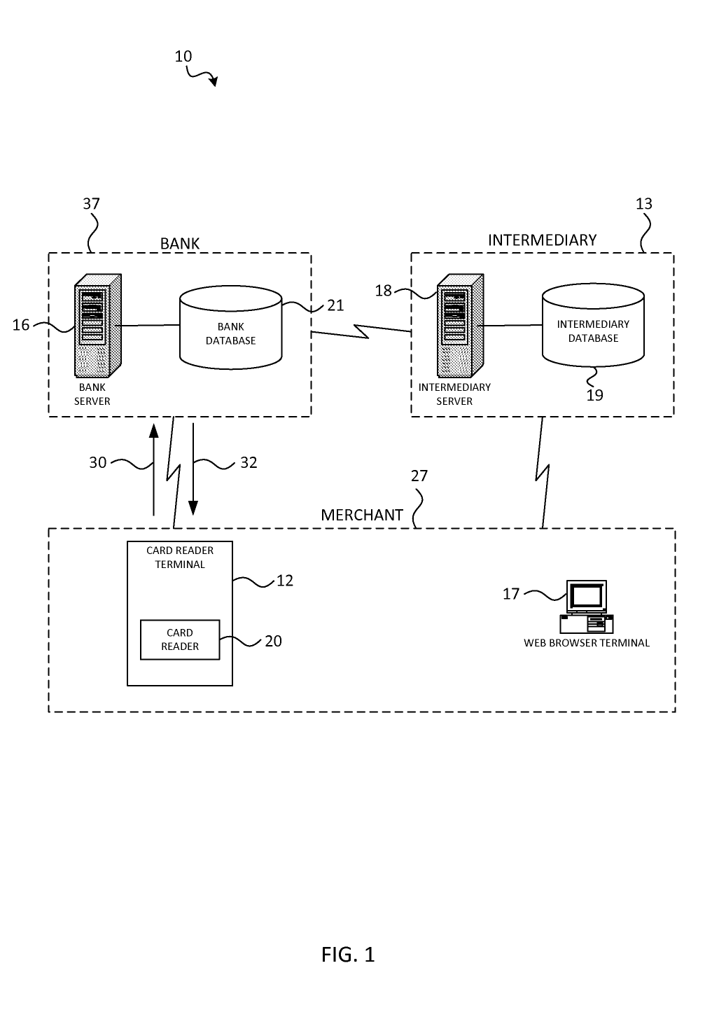

In FIG. 1, reference numeral 10 refers generally to a system for facilitating access to financial information of a bank account holder by a requester (which in this case is a merchant 27), in accordance with the invention.

The system 10 comprises, at the premises of a merchant 27, for example a retail outlet, a card reader terminal 12 having a card reader 20 which is operable, in conventional fashion, to read bank cards (e.g. cards having a magnetic strip and/or a smart chip). The card reader terminal 12 may be in the form of a point-of-sale terminal. The card reader terminal 12 includes a communication arrangement (not illustrated) operable to send and receive electronic communication messages.

The card reader terminal 12 is operable to send electronic messages including details of the bank card read by the bank card reader 20. The card reader terminal 12 is also operable to receive, in conventional fashion, status- and information-type messages, for example indicating the status of a transaction or prompting for input of required information.

Also at the premises of the merchant 27 is a web browser terminal 17 which may be a conventional computer having a web browser client and access to the Internet. It is to be appreciated that the web browser terminal 17 need not necessarily be proximate the card reader terminal 12 or even on the premises of the merchant 27, but it may be more convenient to be nearby.

The system 10 may include a plurality of card reader terminals provided at a number of merchants 27.

The system 10 also comprises, at the side of a bank 37, a bank server 16, for processing requests and transactions, as well as a bank database 21 having stored thereon details and financial information (including account statements) of a plurality of bank account holders. The bank server 16 and the card reader terminal 12 may be in communication with each other to facilitate, for example, card-based transactions in conventional fashion.

Although not necessarily relevant for this example, the server 16 is operable to process (e.g. authorise or decline) transactions involving a bank card (such as a credit card or debit card) by determining whether or not funds are available to authorise the transaction. Typically, the bank database 21 will be interrogated to determine the status of a bank account associated with the bank card thereby to process the transaction. The bank 37 may include a credit card issuer (e.g. Visa, MasterCard)

The system 10 further comprises an intermediary 13 including an intermediary server 18 and an intermediary database 19.

The communication between the intermediary 13 and the bank server 16 may be across existing telecommunications networks, for example the Internet, a mobile telephone network, and the like.

The intermediary 13 may be conceptually thought of as a router or facilitator for providing secure or encrypted financial information to a requester. However, it is to be appreciated that, in a different embodiment (not illustrated) the function of the intermediary 13 could be performed by the bank server 16 and the intermediary 13 could therefore be consolidated into the bank 37.

The card reader 20 is configured to read a bank account holder's bank card and to send a request message 30 to the bank server 16, upon authentication of, and on request of, the bank account holder. The authentication process may be by way of a pin code, receipt of a biometric (e.g. a fingerprint), or any other means utilised by banks to authenticate their bank account holders. The request message 30 includes details of a bank account associated with the bank card and a request to facilitate access to some of the bank account holder's financial information, e.g. three months worth of bank statements, associated with the bank account. The card reader 20 is also configured to receive a response message 32 including codes in the form of a decryption key and a transaction code for decrypting and accessing the financial information. When the response message 32 is received, the card reader terminal 12 prints out the decryption key, the transaction code, an authorisation statement which is to be signed by the bank account holder to authorise the requester to access the financial information, and a link pointing to a specific website.

The bank server 16 is configured to process request messages 30 received via the card reader terminal 12. When a request message 30 is received, the bank server 16 generates a transaction code and retrieves the requested financial information from the bank database 21. The information is then encrypted, using a generated encryption key, and sent to the intermediary server 18 of the intermediary 13, along with the transaction code. The bank server 16 is also configured to send a response message 32 back to the card reader terminal 12, the response message 32 including the transaction code and the decryption key for decrypting and accessing the financial information.

The intermediary server 18 is configured to receive the encrypted financial information, with its associated transaction code, from the bank server 16 and store it on the intermediary database 19. The intermediary server 18 is also configured to allow users to log on to it via the Internet, and to enable logged-on users to send a query message, including the transaction code. If the transaction code is valid, the intermediary server 18 will forward the requester (e.g. the merchant 27) the financial information associated with the code, in encrypted form. The requester may then decrypt the financial information by using the decryption key. Once the financial information has been accessed, it is deleted from the intermediary database 19 to prevent any further access. Similarly, if the financial information is not accessed within a predetermined time, e.g. 48 hours, it is also deleted.

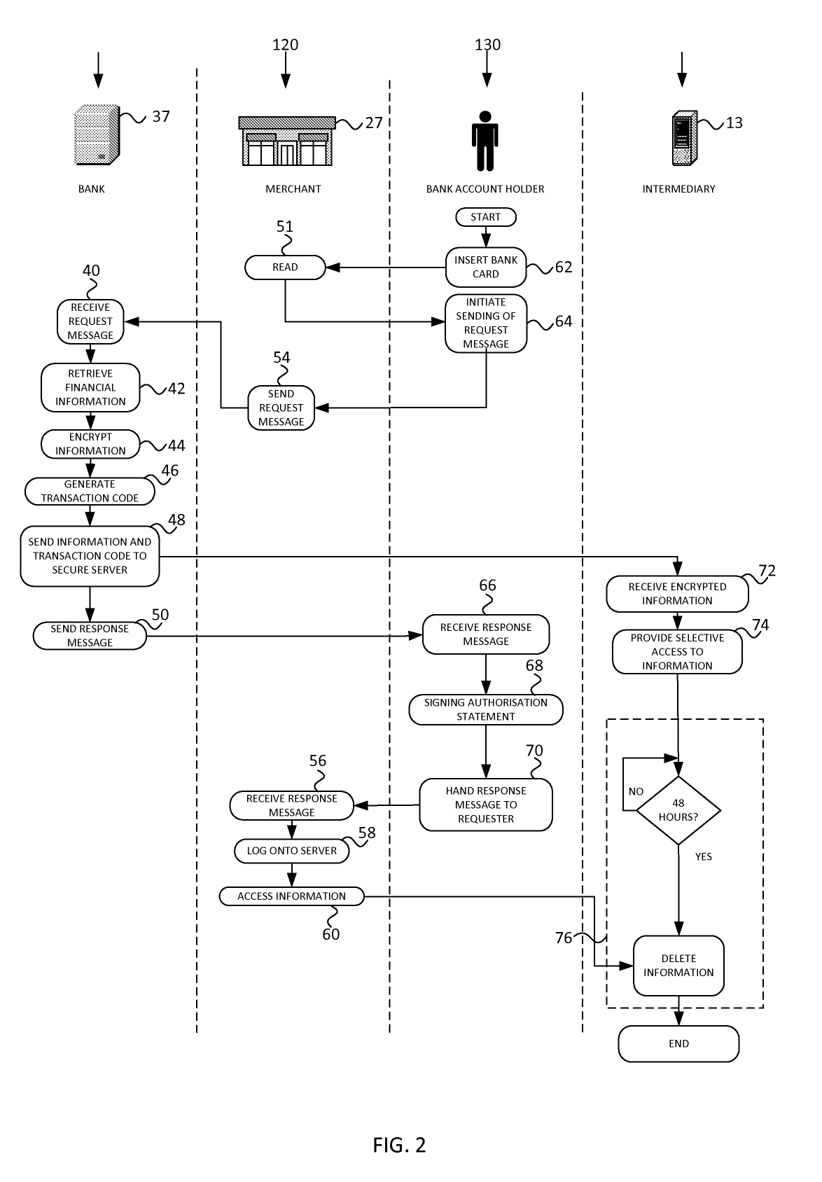

The invention will now be described by way of a few specific examples. Reference is now also made to FIG. 2.

### Example 1

This example, illustrated from the perspective of the bank 37, refers to a method 110 of facilitating access to financial information of a bank account holder by a merchant 27, in accordance with the invention.

The method includes the following steps:
Receiving a request message (block 40).
Retrieving the financial information as requested in the request message (block 42).
Generating an encryption key and encrypting the information using the generated encryption key (block 44).
Generating a transaction code (block 46).
Sending the encrypted information and the transaction code to a secure server (block 48).
Sending a response message back to the sender of the request message, the response message including the transaction code and the decryption key (block 50).

### Example 2

This example, illustrated from the perspective of the merchant 27, refers to a method 120 of facilitating access to financial information of a bank account holder, in accordance with the second aspect of the invention.

The method includes the following steps:
Reading details of a bank account from a bank card by a card reader 20 of a card reader terminal 12 (block 51).
Sending a request message from the card reader terminal 12 (block 54).
Receiving a response message including a transaction code, decryption key, an authorisation statement signed by the bank account holder and a link pointing to a website (block 56).
Logging onto a secure server 18 by using the provided link (block 58).
Accessing the financial information of the bank account holder by entering in the transaction code and receiving the financial information in encrypted form. The financial information is then decrypted by using the decryption key (block 60).

### Example 3

This example, illustrated from the perspective of the bank account holder, refers to a method 130 of facilitating access to financial information to a requester, in accordance with the third aspect of the invention.

The method includes the following steps:
Inserting a bank card into a bank card reader 20 of a card reader terminal 12 (block 62).
Initiating sending of a request message, requesting that certain financial information, associated with the bank card, be made available (block 64).
Receiving a response message including a decryption key and a transaction code (block 66).
Signing a printed authorisation statement (block 68).
Handing the signed authorisation statement to the merchant 27 (block 70).

### Example 4

This example, illustrated from the perspective of the intermediary 13, refers to a method 140 of facilitating access to financial information of a bank account holder by a requester, in accordance with the fourth aspect of the invention.

The method includes the following steps:
Receiving a bank account holder's financial information, in encrypted form, from the bank account holder's bank 37 (block 72).
Providing selective access by the merchant 27 to the financial information through the use of a transaction code (block 74).
Deleting the financial information after it has been accessed once, or if the information is not accessed within 48 hours (block 76).

The Inventor believes that the invention as exemplified will provide business entities (e.g. merchants 27) with secure financial information of their clients (i.e. bank account holders), while at the same time eliminating the need for a bank account holder to go to a bank 37 to obtain the information, thus making it more convenient for the client and also speeding up the transaction process.

1. A method of facilitating access to financial information of a bank account holder by a requester, the method including:
receiving a request message via a card reader terminal, the request message including details of a bank account associated with a bank card read by a card reader of the card reader terminal; and
sending a response message including a code for decrypting or accessing financial information associated with the bank account, the financial information thus being made securely available to the requester.

2. The method of claim 1, wherein the financial information is in the form of at least one bank statement.

3. The method of claim 1, wherein the response message includes at least two codes, namely a transaction code and a decryption key, for accessing the financial information.

4. The method of claim 1, further including generating and sending an information message including the financial information.

5. The method of claim 4, wherein generating the information message includes encrypting the financial information.

6. The method of claim 4, which includes sending the information message to an intermediary for temporary interim storage.

7. The method of claim 4, which includes sending the information message directly to the requester.

8-9. (canceled)

10. A method of facilitating access to financial information of a bank account holder, the method including:
reading from a bank card by a card reader of a card reader terminal details of a bank account associated with the bank card;
sending a request message from the card reader terminal, the request message including the details of the bank account; and
receiving a response message including a code for decrypting or accessing financial information associated with the bank account, the financial information thus being made securely available.

11. The method of claim 10, further including receiving a confirmation from the bank account holder confirming that the financial information may be made available.

12. The method of claim 10, wherein the response message includes an indication of where/how the financial information may be accessed.

13. The method of claim 12, wherein the indication is in the form of a link pointing to a website.

14. The method of claim 10, further including:
receiving a user input indicative of the code;
sending a query message including the code; and
receiving an information message, in response to the code being validated, including the financial information.

15. The method of claim 10, which includes logging on to a secure server through a network to access the financial information.

16. The method of claim 10, wherein the financial information is in the form of at least one bank statement.

17. A method of facilitating access to financial information to a requester, the method including:
inserting a bank card into a card reader of a card reader terminal, thereby allowing details of a bank account associated with the bank card to be read;
initiating sending of a request message, the request message including details of a bank account associated with the bank card; and
receiving a response message including a code for decrypting or accessing financial information associated with the bank account, the financial information thus being made securely available to the requester.

18. The method of claim 17, further including providing a requester with a confirmation confirming that the financial information may be accessed.

19. A method of facilitating access to financial information of a bank account holder by a requester, the method including:
receiving an information message including the financial information of the bank account holder from the bank account holder's bank, the financial information being encrypted by an encryption key; and
providing access to the financial information in response to receiving a valid transaction code.

20. The method of claim 19, wherein the step of providing selective access includes:
receiving a query message including an indication of the transaction code;
validating the transaction code to determine whether or not it is valid; and
forwarding the information message, in response to a determination that the transaction code is valid, including the financial information.

21. A system for facilitating access to financial information of a bank account holder by a requester, the system including a server which is configured to:
receive and process a request message received via a card reader terminal, the request message including details of a bank account associated with a bank card read by a card reader of the card reader terminal; and
send a response message including a code for decrypting or accessing financial information associated with the bank account, the financial information thus being made securely available to the requester.

22. The system of claim 21, wherein the financial information is in the form of at least one bank statement.

23. The system of claim 21, wherein the response message includes at least two codes, namely a transaction code and a decryption key, for accessing the financial information.

24. The system of claim 21, which includes an intermediary which is configured to receive an information message, including financial information, generated and sent from a bank server.

25. The system of claim 24, wherein the bank server is configured to encrypt the financial information prior to sending it to the intermediary.

26. The system of claim 21, wherein the intermediary is configured to provide access to the financial information, in response to receiving a valid code.

27-29. (canceled)

30. A non-transitory computer-readable medium including a set of instructions which, when executed by a computer, causes the computer to perform a method including:
receiving a request message via a card reader terminal, the request message including details of a bank account associated with a bank card read by a card reader of the card reader terminal; and
sending a response message including a code for decrypting or accessing financial information associated with the bank account, the financial information thus being made securely available to the requester.
